(19) United States
(12) Patent Application Publication
(10) Pub. No.: US 2015/0223202 A1
(43) Pub. Date: Aug. 6, 2015

(54) BASE STATION DEVICE, TERMINAL DEVICE, COMMUNICATION SYSTEM, COMMUNICATION METHOD, AND INTEGRATED CIRCUIT

(71) Applicant: Sharp Kabushiki Kaisha, Osaka-shi, Osaka (JP)

(72) Inventors: Takashi Yoshimoto, Osaka-shi (JP); Kozue Yokomakura, Osaka-shi (JP); Ryota Yamada, Osaka-shi (JP); Katsuya Kato, Osaka-shi (JP)

(21) Appl. No.: 14/425,065

(22) PCT Filed: Aug. 27, 2013
(86) PCT No.: PCT/JP2013/072829

§ 371 Date: Mar. 2, 2015

(30) Foreign Application Priority Data
Sep. 19, 2012 (JP) 2012-205283

(51) Int. Cl. H04W 72/00; H04L 5/14

(52) U.S. Cl. CPC H04W 72/005; H04L 5/14

(57) ABSTRACT

Provided are a communication system and a communication method which are capable of preventing control of connection and switching between second base station devices from being complicated in the communication system in which a first base station device and the plurality of second base station devices are disposed so that the second base station devices overlap a cell range of the first base station device. In the communication system in which the first base station device and the plurality of second base station devices are disposed so that the second base station devices overlap the cell range of the first base station device, a transmission unit of the first base station device transmits a broadcast channel for notifying broadcast information of the first base station device and a downlink control channel including broadcast information of the second base station device to a terminal device.

### TECHNICAL FIELD

The present invention relates to a base station device, a terminal device, a communication system, a communication method, and an integrated circuit.

### BACKGROUND ART

In radio communication systems such as wideband code division multiple access (WCDMA (Registered Trademark)) using 3rd generation partnership project (3GPP) and worldwide interoperability for microwave access (WiMAX) using long term evolution (LTE), LTE-advanced (LTE-A), or the institute of electrical and electronics engineers (IEEE), a communication service area is formed by a cell configuration in which a large number of base station devices are disposed. The cell refers to a range in which the base station devices are connectable to a terminal device (mobile station device, user equipment (UE)).

In a system (hereinafter, a cellular system) which is formed by the cell configuration, traffic is required to be distributed in accordance with an increase in a traffic volume due to an increase in a large-capacity service, and the like. In order to meet the requirement, it is proposed that a plurality of base station devices are disposed so that a portion or the entirety of a range of a cell (macrocell) constituted by a main base station device (macro base station) and a range of a cell (picocell, femtocell, small cell, or the like) constituted by a small-power base station device (picocell base station, femtocell base station, small cell base station, or the like) overlap each other (also referred to as heterogeneous network deployment (HetNet) (NPL 1). The term “small-power base station device” used herein refers to a base station device having a maximum transmission power smaller than a maximum transmission power of the macro base station.

FIG. 9 is a schematic diagram of a cellular system in a downlink in which a plurality of base station devices having different cell radii are disposed. The respective base station devices are disposed so that a cell 1000-1a (macrocell) of a macro base station 1000-1 overlaps a cell 1000-2a (small cell) of a base station device 1000-2 and a cell 1000-3a (small cell) of a base station device 1000-3 which are small-power base stations having a maximum transmission power smaller than that of the macro base station device. The base station devices 1000-1, 1000-2, and 1000-3 are connected to each other through an optical fiber, an X2 interface, or other cable lines or radio lines. Necessary control information and the like are exchanged between the base station devices through these lines.

A plurality of mobile station devices are present within the cell. In FIG. 9, a mobile station device 2000-1 is wirelessly connected to the base station device 1000-1 (r11), a mobile station device 2000-2 is wirelessly connected to the base station device 1000-2 (r22), and a mobile station device 2000-3 is wirelessly connected to the base station device 1000-3 (r33). For example, each mobile station device is controlled to be wirelessly connected to a base station device capable of receiving a signal at a maximum received electric field intensity. In this control, for example, a bias is added to the received electric field intensity (NPL 2). Thereby, traffic distribution is realized.

In a cellular system, various pieces of control information (a control channel, a control signal) are transmitted and received between base station devices or between a base station device and a terminal device. FIG. 10 is an example of a transmission frame format in a downlink of a cellular system. In FIG. 10, one transmission frame is constituted by ten subframes (a subframe index #0 to a subframe index #10).

In the frame format of FIG. 10, cell-specific reference signals (CRS; black portions in the drawing), physical downlink shared channels (PDSCH; channels for mainly transmitting information data, white portions in the drawing), physical downlink control channels (PDCCH; hatching portions in the drawing), primary synchronization signals (PSS), secondary synchronization signals (SSS), and physical broadcast channels (PBCH; lattice portions in the drawing) are mapped as physical signals or physical channels of the downlink.

CRS is a signal used for channel estimation. PDSCH is a channel for mainly transmitting information data. PDCCH is a channel used to notify allocation information of a radio resource of a terminal device. PSS is a signal used mainly for symbol timing synchronization. SSS is a signal used for frame synchronization. PBCH is a channel for transmitting control information (for example, a master information block (MIB) in LTE) which is necessary for a terminal device to receive PDSCH.

The base station devices 1000-1, 1000-2, and 1000-3 of FIG. 9 transmit the respective pieces of control information to the terminal devices 2000-1, 2000-2, and 2000-3, respectively, on the basis of the transmission frame format.

### CITATION LIST

### Non Patent Literature

NPL 1: 3rd Generation Partnership Project; Technical Specification Group Radio Access Network; Further Advancements for E-UTRA Physical Layer Aspects (Release 9), 3GPP TR36.814 v9.0.0 (2010-03) URL:http://www.3gpp.org/ftp/Specs/html-info/36814.htm
NPL 2: R1-100607, 3GPP TSG-RAN WG1 meeting #59bis Valencia, Spain, 18-22 Jan. 2010

### SUMMARY OF INVENTION

### Technical Problem

However, in a cellular system in which a plurality of base station devices having different cell radii are disposed, it is considered that the number of small-power base station devices disposed in a range of a macrocell is increased due to load distribution with respect to a further increase in traffic. In this environment, when all of the small-power base station devices have a control function equal to that of a main base station device, there is a problem in that control such as connection, switching, and the like between the base station device and a terminal device becomes complicated.

The present invention is contrived in view of the above-mentioned problem, and an object thereof is to provide a base station device, a terminal device, a communication system, a communication method, and an integrated circuit which allow traffic distribution while preventing control such as connection, switching, and the like between a base station device and a terminal device from becoming complicated in a communication system in which a plurality of base station devices are disposed so that connectable ranges of the respective base station devices entirely or partially overlap each other.

### Solution to Problem

In order to solve the above-described problem, configurations of a base station device, a terminal device, a communication system, a communication method, and an integrated circuit are as follows.

(1) According to one aspect of the present invention, there is provided a base station device of a communication system that includes a first base station device, a plurality of second base station devices disposed so as to overlap a cell range of the first base station device, and a terminal device connected to the first base station device or the second base station device, the base station device including a transmission unit which transmits a broadcast channel for notifying broadcast information of the first base station device and a downlink control channel including system information of the second base station device.

(2) In addition, in the base station device according to one aspect of the present invention, the system information included in the downlink control channel is broadcast information of the second base station device.

(3) In addition, in the base station device according to one aspect of the present invention, the system information included in the downlink control channel is the number of transmitting antennas of the second base station device.

(4) In addition, in the base station device according to one aspect of the present invention, the system information included in the downlink control channel is a system bandwidth of the second base station device.

(5) In addition, in the base station device according to one aspect of the present invention, the system information included in the downlink control channel is a system frame number of the second base station device.

(6) In addition, in the base station device according to one aspect of the present invention, the first base station device includes a higher layer for determining a connection destination of the terminal device from a peripheral base station measurement result, and the higher layer acquires the system information of the second base station device determined to be a connection destination from the second base station device.

(7) In addition, according to one aspect of the present invention, there is provided a transmission method of a first base station device of a communication system that includes the first base station device, a plurality of second base station devices disposed so as to overlap a cell range of the first base station device, and a terminal device connected to the first base station device or the second base station device, the transmission method including transmitting a broadcast channel for notifying broadcast information of the first base station device and a downlink control channel including system information of the second base station device.

(8) In addition, according to one aspect of the present invention, there is provided a terminal device of a communication system that includes a first base station device, a plurality of second base station devices disposed so as to overlap a cell range of the first base station device, and the terminal device connected to the first base station device or the second base station device, the terminal device including a reception unit which receives a broadcast channel for notifying broadcast information of the first base station device and a downlink control channel including system information of the second base station device.

(9) In addition, according to one aspect of the present invention, there is provided a communication system that includes a first base station device, a plurality of second base station devices disposed so as to overlap a cell range of the first base station device, and a terminal device connected to the first base station device or the second base station device, wherein a transmission unit of the first base station device transmits a broadcast channel for notifying broadcast information of the first base station device and a downlink control channel including system information of the second base station device.

(10) In addition, in the communication system according to one aspect of the present invention, the first base station device includes a resource mapping unit that performs resource mapping on the basis of scheduling information for allocating a reference signal, a data channel, a control channel, a broadcast channel, and a synchronization signal, and the second base station device includes a resource mapping unit that performs resource mapping on the basis of scheduling information for allocating a reference signal, a data channel, and a control channel.

(11) In addition, in the communication system according to one aspect of the present invention, the second base station device includes a resource mapping unit that performs resource mapping on the basis of scheduling information for allocating a reference signal, a data channel, a control channel, and a synchronization signal.

(12) In addition, in the communication system according to one aspect of the present invention, the first base station device includes a resource mapping unit that performs resource mapping on the basis of a frame format for performing frequency division duplex, and the second base station device includes a resource mapping unit that performs resource mapping on the basis of a frame format for performing time division duplex.

(13) In addition, according to one aspect of the present invention, there is provided a communication method of a first base station device, a plurality of second base station devices disposed so as to overlap a cell range of the first base station device, and a terminal device connected to the first base station device or the second base station device, wherein the first base station device transmits a broadcast channel for notifying broadcast information of the first base station device and a downlink control channel including system information of the second base station device.

(14) In addition, according to one aspect of the present invention, there is provided an integrated circuit of a first base station device of a communication system that includes the first base station device, a plurality of second base station devices disposed so as to overlap a cell range of the first base station device, and a terminal device connected to the first base station device or the second base station device, wherein the integrated circuit has a function of transmitting a broadcast channel for notifying broadcast information of the first base station device and a downlink control channel including system information of the second base station device.

### Advantageous Effects of Invention

According to the present invention, in a communication system in which a plurality of base station devices are disposed so that connectable ranges of the respective base station devices are entirely or partially overlap each other, control information of a small-power base station device can be reduced, and thus it is possible to prevent control such as connection, switching, and the like between the base station device and a terminal device from becoming complicated. Therefore, it is possible to realize a radio communication system having a small connection delay.

### BRIEF DESCRIPTION OF DRAWINGS

FIG. 1 is a schematic diagram showing an example of a communication system in a downlink in which a plurality of base station devices, according to a first embodiment, which have different cell radii are disposed.

FIG. 2 is a block diagram showing a first base station device according to the first embodiment.

FIG. 3 is a block diagram showing a second base station device according to the first embodiment.

FIG. 4 is an aspect of a transmission frame format in the communication system according to the first embodiment.

FIG. 5 is another aspect of a transmission frame format in the communication system according to the first embodiment.

FIG. 6 is a block diagram showing a terminal device according to the first embodiment.

FIG. 7 is a sequence diagram showing the terminal device, in the communication system according to the first embodiment, being connected to the second base station device.

FIG. 8 is a sequence diagram showing a terminal device, in a communication system according to a second embodiment, being connected to a second base station device.

FIG. 9 is a schematic diagram of a cellular system in a downlink in which a plurality of base station devices having different cell radii are disposed.

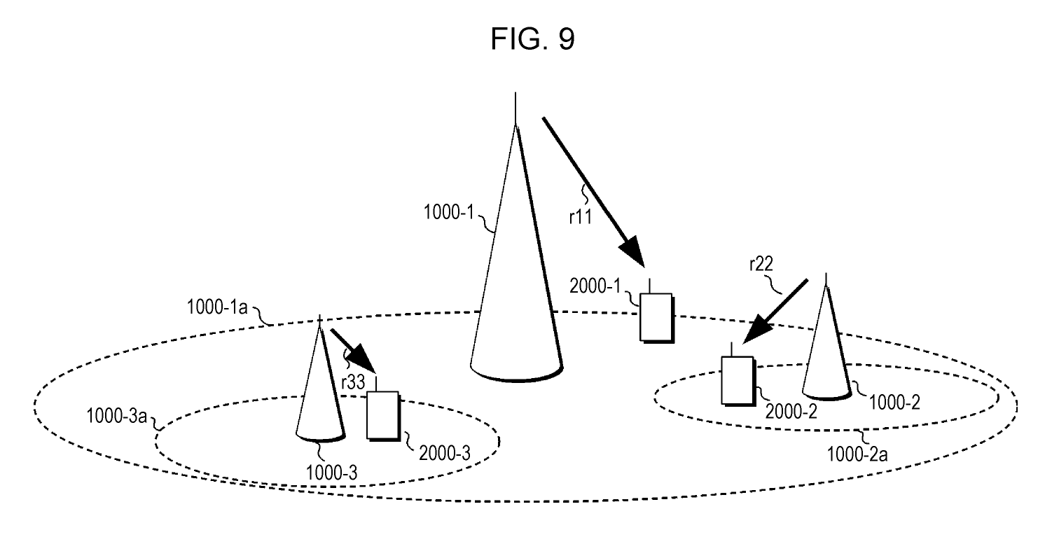

FIG. 10 is an example of a transmission frame format in a downlink of a cellular system.

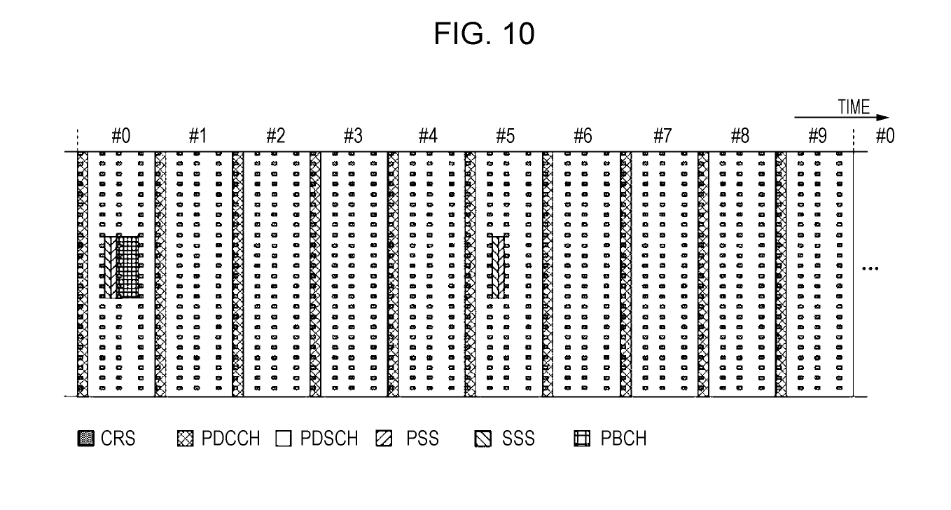

### DESCRIPTION OF EMBODIMENTS

Hereinafter, embodiments of the present invention will be described with reference to the accompanying drawings.

In the following embodiment, a description will be given of an example in which a base station device (eNodeB, a transmission station, a transmission device, a transmission point, and an access point (AP)) and a terminal device ((a terminal, a mobile station device, a mobile terminal, a reception point, a reception terminal, a reception device, a user equipment (UE)) which constitute a communication system perform data transmission using an orthogonal frequency division multiplexing (OFDM) scheme. Meanwhile, the present embodiment is not limited thereto, and other transmission schemes, for example, a single carrier transmission scheme such as narrowband single carrier transmission, single carrier-frequency division multiple access (SC-FDMA), or discrete Fourier transform-spread-OFDM (DFT-s-OFDM) and a multicarrier transmission scheme such as multiple carrier-code division multiple access (MC-CDMA) may be used. In addition, examples of the communication system according to the embodiment of the present invention include a radio communication system such as wideband code division multiple access (W-CDMA) using 3rd generation partnership project (3GPP) and worldwide interoperability for microwave access (WiMAX) using long term evolution (LTE), LTE-advanced (LTE-A), or the institute of electrical and electronics engineers (IEEE), but are not limited thereto.

### First Embodiment

A communication system according to an embodiment of the present invention includes a plurality of base station devices and a plurality of terminal devices.

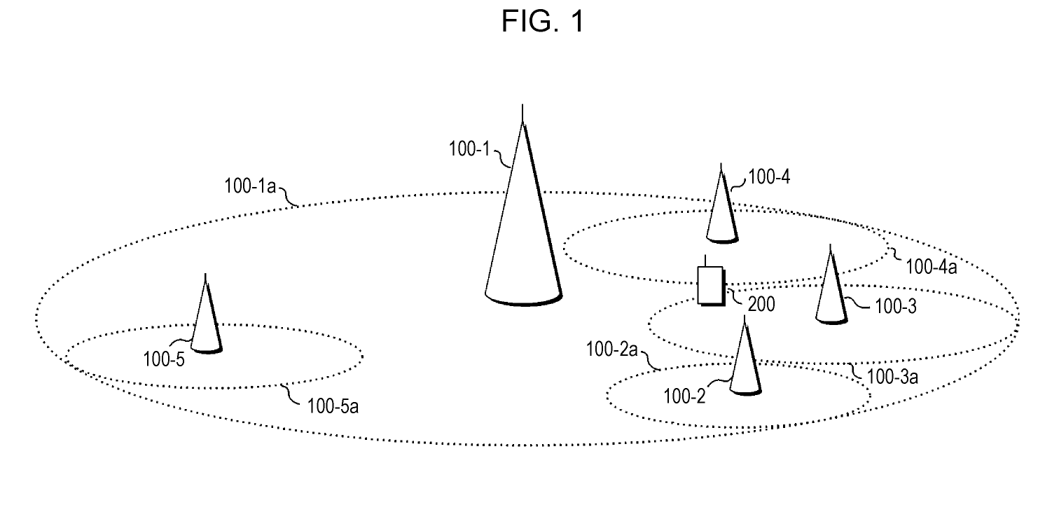

FIG. 1 is a schematic diagram showing an example of a communication system in a downlink in which a plurality of base station devices, according to a first embodiment, which have different cell radii are disposed.

In FIG. 1, base station devices 100-2 to 100-5 (second base station devices, small cell base station devices) are disposed such that cells 100-2a to 100-5a (for example, small cells) thereof overlap a cell 100-la (for example, a macrocell) of a base station device 100-1 (a first base station device, a macrocell base station device). System frequencies of the first base station device and the second base station device may be different from each other. Transmission powers of the first base station device and the second base station device may be different from each other. The second base station device may be disposed indoors. The second base station device can be densely disposed within the cell of the first base station device.

The base station device of a small cell can be set as a base station device having a transmission power smaller than that of the base station device of a macrocell. Distinction between the macrocell base station and the small cell base station may be performed between a cell, having backward compatibility, which supports a scheme having been already serviced, and a cell, having no backward compatibility, which is newly defined.

The base station devices are connected to each other through a backhaul line using a cable line or a radio line such as an optical fiber, the Internet line, or an X2 interface. A terminal device 200 is a terminal device which is present within the cell 100-la of the base station device 100-1.

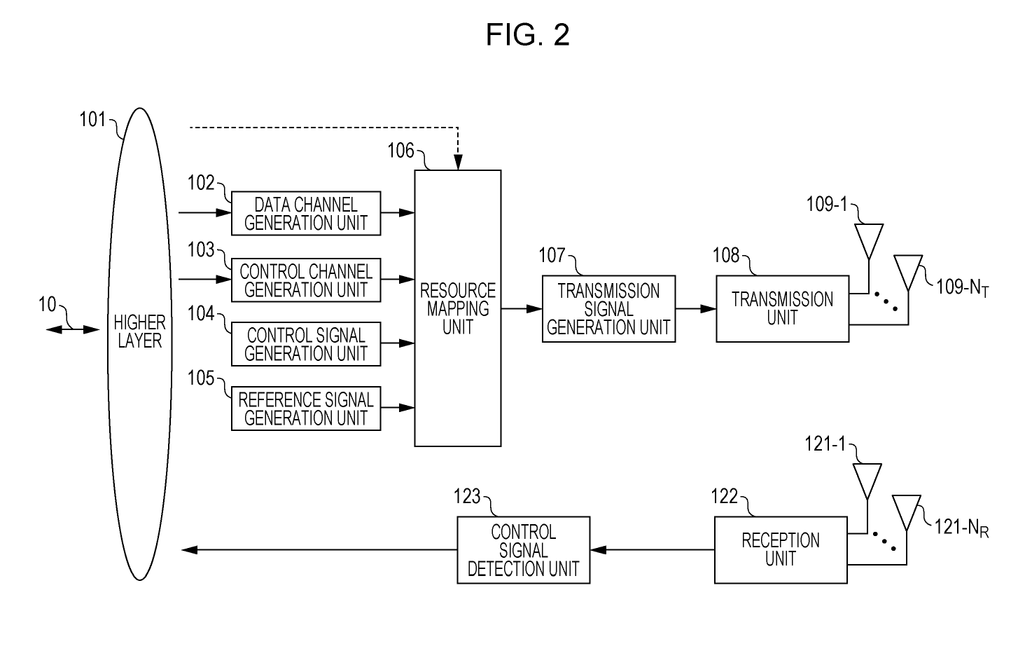

FIG. 2 is a block diagram showing the first base station device according to the first embodiment.

The first base station device is configured to include a higher layer 101, a data channel generation unit 102, a control channel generation unit 103, a control signal generation unit 104, a reference signal generation unit 105, a resource mapping unit 106, a transmission signal generation unit 107, a transmission unit 108, transmitting antenna units 109-1 to 109-NT, reception antenna units 121-1 to 121-NR, a reception unit 122, and a control signal detection unit 123. Here, NT is the number of transmitting antennas, and NR is the number of reception antennas. In addition, the higher layer 101 is connected to the second base station device through a backhaul line 10. Meanwhile, when a portion or the entirety of the first base station device is formed into a chip and is configured as an integrated circuit, a chip control circuit (not shown) performing control on each functional block is provided.

The first base station device receives a signal (uplink signal) which is transmitted from the terminal device 200, through the reception antenna unit 121-x (x=1, . . . NR). The signal of the uplink includes a data channel, a control channel, and a reference signal in the uplink.

The data channel is a channel used to transmit user data of the uplink. As the data channel, for example, a physical uplink shared channel (PUSCH) may be used in LTE-A.

The control channel includes a signal (channel statement information) which indicates a peripheral base station measurement result. In addition, the control channel includes a signal (channel quality control) for notifying the reception quality of a downlink, a scheduling allocation request signal, and the like. For example, in LTE-A, a physical uplink control channel (PUCCH) may be used. In addition, as the peripheral base station measurement result, measurement reports or the like may be used in LTE-A.

In addition, the control channel includes a random access channel. The random access channel is used in a case where a terminal device performs connection establishment with respect to a cell through initial access, handover, or the like.

The reference signal is used for channel estimation, symbol timing synchronization, reception quality measurement of the uplink, and the like. For example, as the reference signal, a CRS, a channel state information-reference signal (CSI-RS), a demodulation reference signal (DMRS), a sounding reference signal (SRS) in LTE or LTE-A, and the like may be used.

The reception unit 122 down-converts (wirelessly frequency-converts) a signal received in the antenna 121 into a frequency band capable of digital signal processing such as a signal detection process, performs a filtering process for removing spurious, and converts the filtered signal from an analog signal to a digital signal (analog to digital conversion).

The control signal detection unit 123 performs a demodulation process, a decoding process, and the like on a signal which is output from the reception unit 122. Thereby, it is possible to acquire the above-mentioned various signals (uplink data channel, uplink control channel, and the like) from the uplink signal.

The higher layer 101 generates information data (a transport block, a cord word) with respect to a terminal device and outputs the data to the data channel generation unit 102. Here, the information data can be set as a unit to be subjected to an error correction coding process. In addition, the information data can be set as a unit to be subjected to retransmission control such as hybrid automatic repeat request (HARQ). In addition, the first base station device can transmit a plurality of pieces of information data to a terminal device. Here, the higher layer is a layer, for example, a data link layer and a network layer, having a function which is of a higher level than a physical layer, among layers having a communication function defined in an OSI reference model.

The higher layer 101 acquires the signal for notifying the reception quality of the downlink and the scheduling allocation request signal from the control signal detection unit 123. The higher layer 101 performs scheduling of a data channel on the basis of the signal for notifying the reception quality of the downlink and the scheduling allocation request signal. The term “scheduling” used herein refers to determination of a resource element for mapping a data channel, a control channel, and/or a reference signal. In addition, the term “resource element” used herein refers to a minimum unit for disposing a signal, and refers to a unit for disposing a signal constituted by one subcarrier and one OFDM symbol in OFDM transmission.

The higher layer 101 notifies the control channel generation unit 103 of a base station device candidate serving as the next connection destination of a terminal device connected to the first base station device. For example, the higher layer notifies of a cell ID of the base station device candidate.

The higher layer 101 acquires the peripheral base station measurement result from the control signal detection unit 123. The higher layer 101 determines a base station device (target base station device) serving as a connection destination of the terminal device using the peripheral base station measurement result and other signals related to radio resource management. The higher layer requests the target base station device to determine whether or not connection can be performed, through the backhaul line 10 (connection request).

The higher layer 101 acquires the connection propriety and system information of the target base station device from the target base station device requested to be connected, through the backhaul line 10. The system information includes the number of transmitting antennas, a system bandwidth, and a system frame number of the target base station device. The system information may include broadcast information of the target base station device. For example, a master information block (MIB) can be used in LTE-A. In addition, the system information may include the number of reception antennas of the target base station device.

The higher layer 101 can hold information such as the number of transmitting antennas, the system bandwidth, and the system frame number which have been notified from the target base station device.

The higher layer 101 notifies the target base station device of terminal information of the terminal device connected thereto, an unreached packet, and the like through the backhaul line 10.

The data channel generation unit 102 (data channel region allocation unit, data channel mapping unit, common-use channel generation unit) performs adaptive control on the information data which is output from the higher layer 101 to thereby generate a data channel (common-use channel, shared channel, physical downlink shared channel (PDSCH)) for a terminal. Specifically, the adaptive control in the data channel generation unit 102 includes a coding process for performing error correction coding, a scramble process for performing a scramble code specific to the terminal, a modulation process for using a multilevel modulation scheme (BPSK, QPSK, QAM, and the like), a layer mapping process for performing spatial multiplexing such as MIMO, and the like. Here, in the layer mapping process in the data channel generation unit 102, mapping to one or more layers (streams) is performed on the basis of the number of ranks set with respect to the terminal.

The control channel generation unit 103 generates a downlink control channel. The downlink control channel includes downlink control information (DCI). The downlink control information includes information regarding resource allocation of a data channel, a modulation and coding scheme (MCS), information regarding the number of spatial multiplexings (for example, a rank indicator (RI)), information regarding scrambling identity (also referred to as a scrambling identifier), information regarding reference signal sequence identity (also referred to as base sequence identity, a base sequence identifier, or a base sequence index), and the like.

The downlink control channel includes a signal to the effect that the terminal device connected thereto is requested to measure communication quality between a peripheral base station device and the terminal device (peripheral base station measurement control). The peripheral base station measurement control may include a cell ID of the target base station candidate notified from the higher layer 101.

The downlink control channel includes information for giving an instruction to be connected to a target base station device which is notified from the higher layer 101. The information for giving an instruction of connection may include a cell ID of the target base station device.

The downlink control channel includes the system information of the target base station device which is notified from the higher layer 101.

The control channel generation unit 103 performs a data modulation process and a precoding process on the downlink control channel.

The control channel generation unit 103 includes broadcast information (for example, a physical broadcast channel (PBCH) of LTE) of the first base station device.

The control signal generation unit 104 generates a synchronization signal for establishing and following synchronization between the first base station device and a terminal device, such as symbol synchronization or frame synchronization. As the synchronization signal, a primary synchronization signal (PSS) and a secondary synchronization signal (SSS) of LTE and LTE-A may be used.

The reference signal generation unit 105 generates a reference signal (pilot signal) and outputs the reference signal to the resource mapping unit 106. The reference signal is a signal used when each mobile station device estimates communication quality between its own base station device and a base station device that transmits the reference signal. The communication quality includes a channel, a received power, an interference power, a reception signal to noise power ratio (SNR), a reception signal to interference and noise power ratio (SINR), and the like.

The resource mapping unit 106 allocates the data channel output from the data channel generation unit 102, the control channel output from the control channel generation unit 103, the control signal output from the control signal generation unit 104, and the reference signal output from the reference signal generation unit 105 to the resource elements, on the basis of the resource allocation (scheduling information) of the data channel, the control channel, the control signal, and the reference signal which are notified from the higher layer 101.

The transmission signal generation unit 107 generates an OFDM signal. Specifically, the transmission signal generation unit performs inverse discrete Fourier transform (IDFT) on a frequency domain signal which is input from the resource mapping unit 106 to thereby convert the signal into a time domain signal. In addition, the transmission signal generation unit 107 adds a guard interval (GI, also referred to as a guard section) to the time domain signal (referred to as a valid symbol) to thereby generate an OFDM symbol. The term “GI” used herein refers to a section which is added for the purpose of preventing the OFDM symbols at the previous and subsequent times from interfering with each other. Here, GI includes, for example, a cyclic prefix (CP). For example, a GI insertion unit 110 disposes a copy of a portion of a latter section of the valid symbol at the front of the valid symbol, as a GI. Therefore, the valid symbol having the GI disposed at the front thereof serves as an OFDM symbol.

The transmission unit 108 digital-to-analog (D/A) converts the OFDM symbol to thereby generate an analog signal. The transmission unit 108 performs band limiting on the generated analog signal through a filtering process to thereby generate a band-limited signal. The transmission unit 108 up-converts the generated band-limited signal into a radio frequency band and outputs the converted signal to the transmitting antenna units 109-1 to 109-NT.

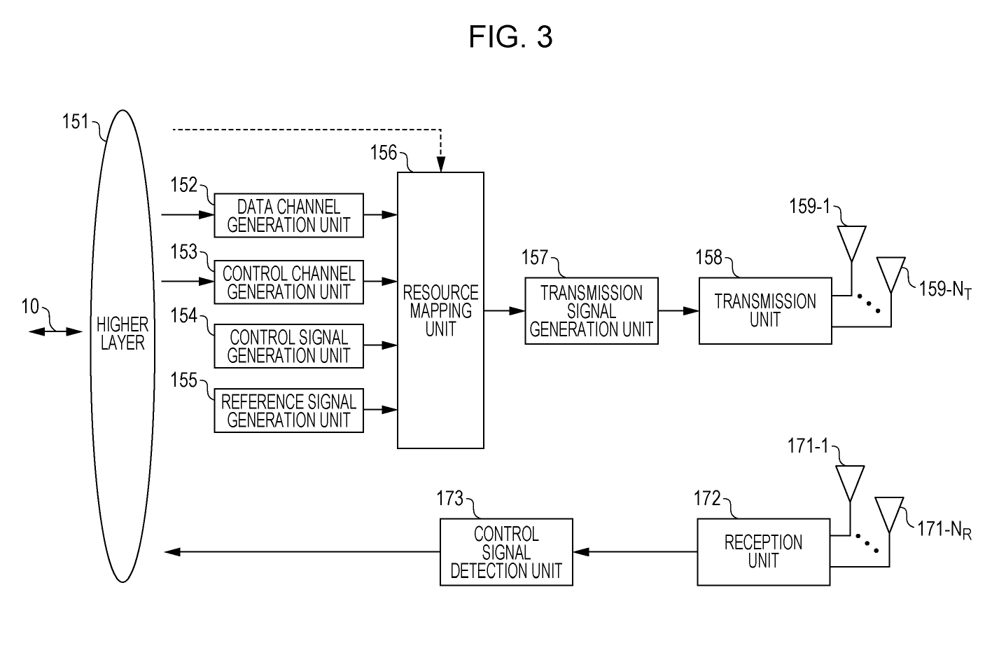

FIG. 3 is a block diagram showing a second base station device according to the first embodiment.

The second base station device is configured to include a higher layer 151, a data channel generation unit 152, a control channel generation unit 153, a control signal generation unit 154, a reference signal generation unit 155, a resource mapping unit 156, a transmission signal generation unit 157, a transmission unit 158, transmitting antenna units 159-1 to 159-NT, reception antenna units 171-1 to 171-NR, a reception unit 172, and a control signal detection unit 173. Meanwhile, when a portion or the entirety of the second base station device is formed into a chip and is configured as an integrated circuit, a chip control circuit (not shown) performing control on each functional block is provided. In addition, the higher layer 151 can be connected to the first base station device and other second base station devices through the backhaul line 10.

The second embodiment receives a signal (uplink signal) which is transmitted from the terminal device 200, through the reception antenna unit 171-x (x=1, . . . , NR). The reception unit 172 down-converts (wirelessly frequency-converts) a signal received in the antenna 171-x into a frequency band capable of digital signal processing such as a signal detection process, performs a filtering process for removing spurious, and converts the filtered signal from an analog signal to a digital signal (analog to digital conversion). The control signal detection unit 173 performs a demodulation process, a decoding process, and the like on a signal which is output from the reception unit 172. Thereby, it is possible to acquire various signals (uplink, uplink control channel, and the like) which are included in the uplink signal.

The higher layer 151 has a function of determining the presence or absence of connection permission with respect to a connection request from the first base station device, through the backhaul line 10. The higher layer 151 can generate system information to be notified to a terminal device. The system information includes the number of transmitting antennas, a system bandwidth, and a system frame number of a target base station device. For example, a master information block (MIB) can be used in LTE-A. In addition, the system information may include the number of reception antennas of the target base station device. The higher layer 151 can notify the first base station device of the connection permission and the system information, through the backhaul line 10.

The higher layer 151 can acquire terminal information of a terminal device connected to its own base station device and an unreached packet from the first base station device through the backhaul line 10. The higher layer 151 generates information data (a transport block, a cord word) with respect to a terminal device and outputs the data to the data channel generation unit 152. The higher layer 151 notifies the control channel generation unit 153 of downlink control information or the like used when the control channel generation unit 153 generates a control channel. The data channel generation unit 152 performs adaptive control on the information data which is output from the higher layer 151 to thereby generate a data channel for a terminal.

The control channel generation unit 153 generates a downlink control channel. The downlink control channel includes downlink control information (DCI). The downlink control information includes information regarding resource allocation of a data channel, a modulation and coding scheme (MCS), information regarding the number of spatial multiplexings (RI), information regarding scrambling identity (also referred to as a scrambling identifier), information regarding reference signal sequence identity (also referred to as base sequence identity, a base sequence identifier, or a base sequence index), and the like. The control channel generation unit 153 performs a data modulation process and a precoding process on the downlink control channel.

The resource mapping unit 156 allocates the data channel output from the data channel generation unit 152, the control channel output form the control channel generation unit 153, the control signal output from the control signal generation unit 154, and the reference signal output from the reference signal generation unit 155 to resource elements, on the basis of the resource allocation (scheduling information) of the data channel, the control channel, the control signal, and the reference signal which are notified from the higher layer 151.

The control signal generation unit 154 can generate a synchronization signal for establishing and following synchronization between the second base station device and a terminal device, such as symbol synchronization or frame synchronization. The reference signal generation unit 155 generates a reference signal (pilot signal) and outputs the reference signal to the resource mapping unit 156.

The transmission signal generation unit 157 generates an OFDM signal from the signal input from the resource mapping unit 156. The transmission unit 158 D/A-converts the OFDM symbol to generate an analog signal. The transmission unit 158 performs band limiting on the generated analog signal through a filtering process to thereby generate a band-limited signal. The transmission unit 158 up-converts the generated band-limited signal into a radio frequency band and outputs the converted signal to the transmitting antenna units 159-1 to 159-NT.

According to the above-mentioned first base station device and second base station device, it is possible to reduce a control channel transmitted from the second base station device. Specifically, it is possible to reduce control information transmitted by a downlink control channel. In addition, it is possible to reduce control information transmitted by a broadcast channel. Therefore, it is possible to prevent control such as connection, switching, and the like between a base station device and a terminal device with respect to a plurality of base station devices which are disposed so as to overlap the cell of the first base station device.

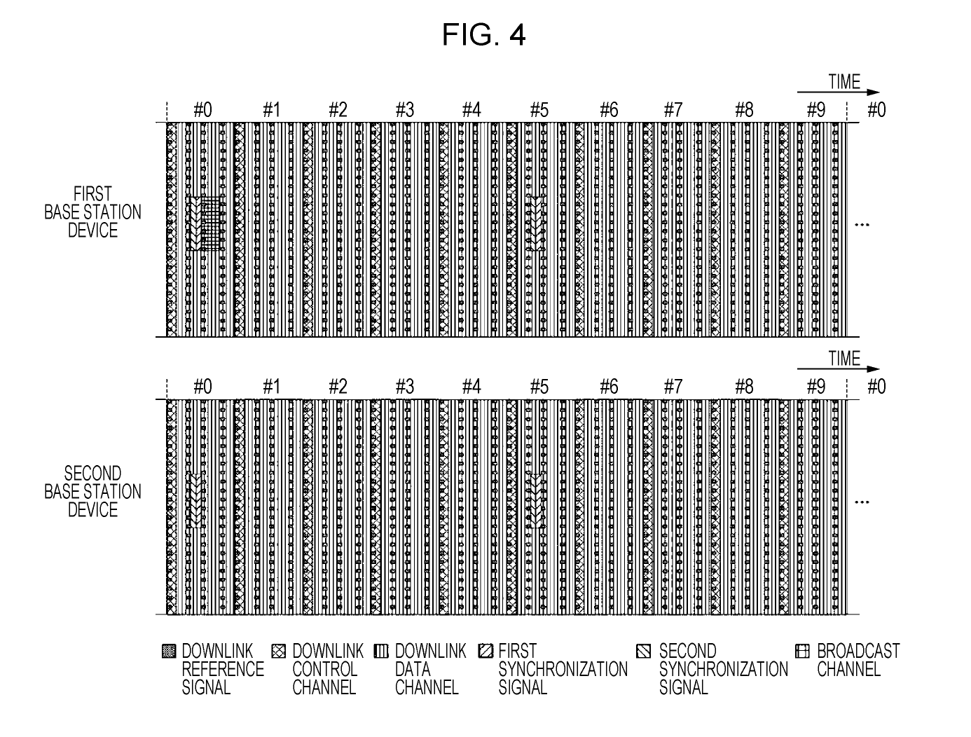

FIG. 4 is an aspect of a transmission frame format in the communication system according to the first embodiment. In FIG. 4, one transmission frame format is constituted by ten subframes (#0 to #9).

The upper stage of FIG. 4 is a transmission frame format in a downlink of the first base station device. The higher layer 101 of the first base station device notifies the resource mapping unit 106 of scheduling information in accordance with the format of the upper stage of FIG. 4. The resource mapping unit 106 of the first base station device can allocate the data channel output from the data channel generation unit 102, the downlink control channel and the broadcast channel which are output from the control channel generation unit 103, the synchronization signal output from the control signal generation unit 104, and the reference signal output from the reference signal generation unit 105 to resource elements, in accordance with the scheduling information.

The lower stage of FIG. 4 is a transmission frame format in a downlink of the second base station device. The higher layer 151 of the second base station device notifies the resource mapping unit 156 of scheduling information in accordance with the format of the lower stage of FIG. 4. The resource mapping unit 156 of the second base station device can allocate the data channel output from the data channel generation unit 102, the downlink control channel output from the control channel generation unit 103, the synchronization signal output from the control signal generation unit 104, and the reference signal output from the reference signal generation unit 105 to resource elements, in accordance with the scheduling information.

According to the above-mentioned transmission frame formats of the first base station device and the second base station device, it is possible to omit mapping of a broadcast channel in the second base station device. Therefore, a large number of radio resources can be allocated to data transmission in a plurality of base station devices which are disposed so as to overlap the cell of the first base station device.

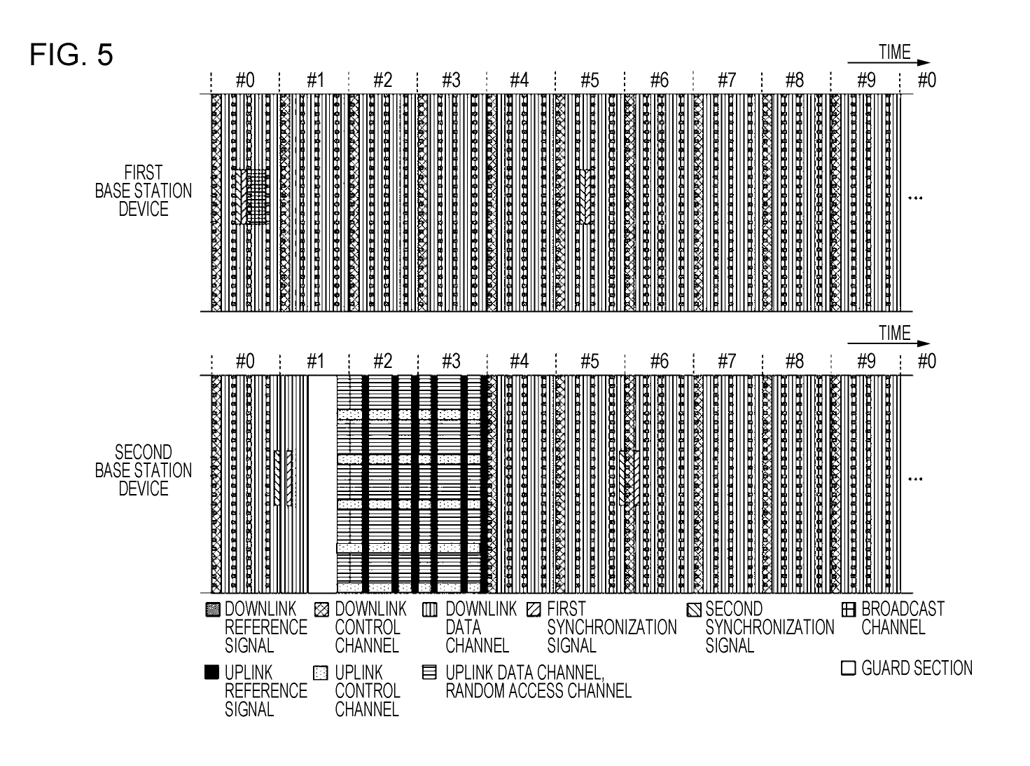

FIG. 5 is another aspect of a transmission frame format in the communication system according to the first embodiment. FIG. 5 shows a case where the second base station device performs communication of an uplink and a downlink with a terminal device connected thereto by time division duplex (TDD). In FIG. 5, one transmission frame format is constituted by ten subframes (#0 to #9).

The upper stage of FIG. 5 is a transmission frame format in a downlink of the first base station device. The upper stage of FIG. 5 is a transmission frame format of a downlink of frequency division duplex (FDD). The upper stage of FIG. 5 is the same format as the upper stage of FIG. 4, and the resource mapping unit 106 of the first base station device performs resource mapping in the same manner as in the description of the upper stage of FIG. 4.

The lower stage of FIG. 5 is a transmission frame format of the second base station device. In the format of the lower stage of FIG. 5, subframe indexes #0 and #4 to #9 are subframes to which a signal of a downlink is mapped. Subframe indexes #3 and #4 are subframes to which a signal of an uplink is mapped. A subframe index #2 is a subframe (also referred to as a special subframe) which has a guard section in order to prevent complication at the time of switching from an uplink to a downlink.

The higher layer 151 of the second base station device notifies the resource mapping unit 156 of scheduling information in accordance with the format of the lower stage of FIG. 5.

The resource mapping unit 156 of the second base station device can allocate the downlink data channel output from the data channel generation unit 102, the downlink control channel output from the control channel generation unit 103, the synchronization signal output from the control signal generation unit 104, and the downlink reference signal output from the reference signal generation unit 105 to resource elements, in accordance with the scheduling information.

According to the above-mentioned transmission frame formats of the first base station device and the second base station device, it is possible to omit mapping of a broadcast channel in the second base station device. Therefore, a large number of radio resources can be allocated to data transmission in a plurality of base station devices which are disposed so as to overlap the cell of the first base station device. Further, the resource mapping of various signals can be performed in accordance with a transmission scheme (FDD, TDD) depending on communication environments (the magnitude of transmission power and the like) of the first base station device and the second base station device.

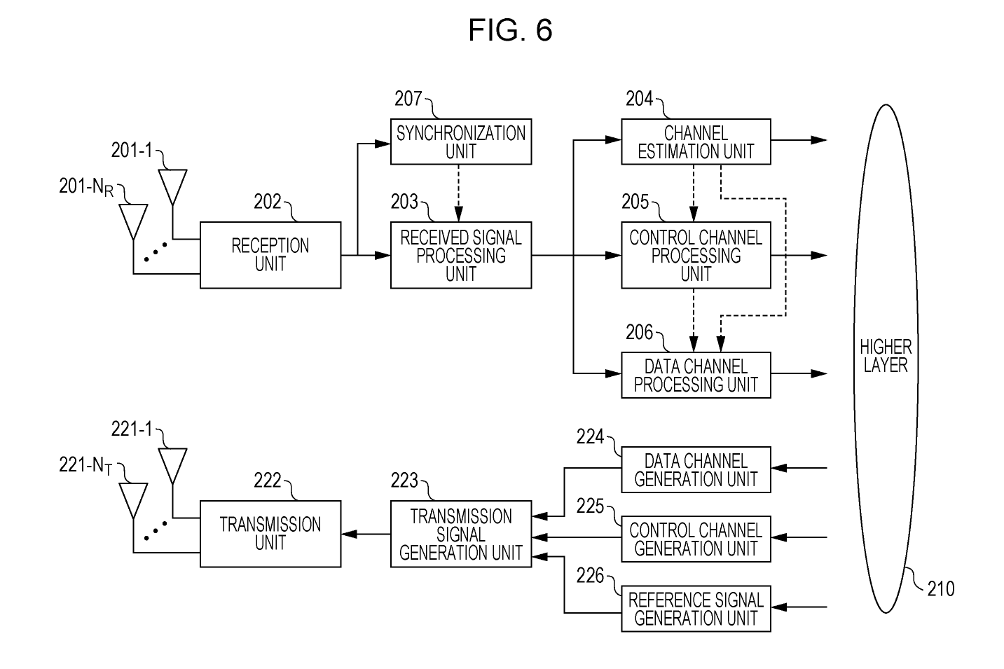

FIG. 6 is a block diagram showing the terminal device according to the first embodiment. The terminal device is configured to include reception antenna units 201-1 to 201-NR, a reception unit 202, a received signal processing unit 203, a channel estimation unit 204, a control channel processing unit 205, a data channel processing unit 206, a synchronization unit 207, a higher layer 210, transmitting antenna units 221-1 to 221-NT, a transmission unit 222, a transmission signal generation unit 223, a data channel generation unit 224, a control channel generation unit 225, and a reference signal generation unit 226. Meanwhile, when a portion or the entirety of the terminal device is formed into a chip and is configured as an integrated circuit, a chip control circuit (not shown) performing control on each functional block is provided.

The reception antenna units 201-1 to 201-NR receive a carrier band OFDM signal propagated as radio waves from the first base station device or the second base station device and outputs the received carrier band OFDM signal to the reception unit 202. When a frequency band of a transmission signal of the first base station device is different from that of the second base station device, the terminal device may include the reception antenna units 201-1 to 201-NR compatible with each frequency band.

The reception unit 202 down-converts the OFDM signals input from the reception antenna units 201-1 to 201-NR into a frequency band capable of performing digital signal processing and further performs a filtering process on the down-converted signals to thereby remove unnecessary components (spurious). The reception unit 202 (analog-to-digital (A/D))-converts the signals having been subjected to the filtering process from analog signals to digital signals and outputs the converted digital signals to the received signal processing unit 203 and the synchronization unit 207.

The synchronization unit 207 establishes symbol synchronization and frame synchronization with respect to signals transmitted from the first base station device and the second base station device, using a synchronization signal (for example, PSS, SSS) included in the input signal. The received signal processing unit 203 performs a process of decoding OFDM modulation on the digital signal input from the reception unit 202 in accordance with a symbol synchronization timing and a frame synchronization timing which are input from the synchronization unit 207. Specifically, the removal of a GI length and a DFT (IFFT) process are performed.

The channel estimation unit 204 performs channel estimation using a downlink reference signal included in the signal output from the received signal processing unit 203. The channel estimate is input to the control channel processing unit 205, the data channel processing unit 206, and the higher layer 210. The channel estimate includes, for example, a transfer function, an impulse response, and the like. The channel estimation unit 204 can measure channel quality between the terminal device and the first base station device or the second base station device (channel state measurement) using a downlink reference signal included in the signal output from the received signal processing unit 203. For example, the channel quality corresponds to a received power, an interference power, a reception SNR, a reception SINR, and the like.

The control channel processing unit 205 performs detection (channel compensation based on the channel estimate, a demodulation process, and a decoding process) of a downlink control channel (for example, PDCCH and radio resource control (RRC) signaling) which is included in the signal output from the received signal processing unit 203. When the control channel processing unit 205 extracts control information such as an MCS performed on a data channel, a precoding matrix, and the number of layers which is included in the downlink control channel, the control channel processing unit notifies the data channel processing unit 206 of the extraction.

When the control channel processing unit 205 extracts a signal regarding peripheral base station measurement control which is included in the downlink control channel, the control channel processing unit notifies the higher layer 210 of the extraction. When the control channel processing unit 205 extracts a signal regarding a connection instruction which is included in the downlink control channel, the control channel processing unit notifies the higher layer 210 of the extraction. When the control channel processing unit 205 extracts system information regarding the second base station device which is included in the downlink control channel, the control channel processing unit notifies the higher layer 210 of the extraction. When the control channel processing unit 205 extracts uplink data channel control information such as an MCS performed on an uplink data channel and scheduling allocation which is included in the downlink control channel, the control channel processing unit notifies the higher layer 210 of the extraction.

The data channel processing unit 206 performs detecton (channel compensation based on the channel estimate, a demodulation process, and a decoding process) of a downlink data channel included in the signal output from the received signal processing unit 203, and inputs the downlink data channel to the higher layer 210.

The higher layer 210 can select a base station device to be connected thereto from a channel state between a terminal device and a peripheral base station device which is input from the channel estimation unit 204, and can input the result thereof (peripheral base station measurement result) to the transmission signal generation unit 223. The higher layer 210 extracts information data from the downlink data channel which is input from the data channel processing unit 206.

The data channel generation unit 224 performs adaptive control (error correction coding, data modulation, and the like) on the information data output from the higher layer 210 to thereby generate a data channel (for example, a physical uplink shared channel (PUSCH)) for the base station device.

The control channel generation unit 225 generates an uplink control channel. The uplink control channel includes the peripheral base station assumption result. In addition, the control channel generation unit 225 generates a random access channel which is used to perform synchronization of an uplink. The reference signal generation unit 226 generates a reference signal (for example, a DMRS and an SRS) which is used for the channel estimation of an uplink and reception quality measurement required to apply frequency scheduling.

The transmission signal generation unit 223 performs the resource mapping of the uplink data channel, the uplink control channel, the random access channel, and the reference signal in accordance with a transmission format of the uplink and performs multicarrier modulation (SC-FDMA, OFDM, and the like) to thereby generate a transmission signal of the uplink.

The output signal of the control signal generation unit 223 is up-converted up to a frequency band in which transmission by the transmission unit 222 can be performed in un uplink, and is transmitted to a base station device through the transmitting antenna units 221-1 to 221-NT.

Next, connection operations of the first base station device, the second base station device, and the terminal device in the communication system according to the first embodiment will be described. In FIG. 1, when power is supplied, the terminal 200 performs cell searching of a base station device to be connected thereto. Here, the terminal 200 searches for a base station device to be connected thereto in the first base station device. The terminal device 200 performs cell searching using a synchronization sequence (synchronization channel) which is generated on the basis of a cell ID allocated to the first base station device. In addition, the terminal device 200 performs cell searching only on a frequency band of the first base station device, and thus searches for a base station device to be connected thereto from the first base station device. In the communication system of the present embodiment, it is possible to distinguish between the first base station device and the second base station device by allocating synchronization channels to different resource elements in the first base station device and the second base station device. In this case, the terminal device performs cell searching on a base station device to be connected thereto by the resource allocation of the synchronization channel in the first base station device.

The terminal device 200 receives a broadcast channel of the selected first base station device after cell searching to thereby establish connection with the first base station device. In FIG. 1, the base station device 100-1 is selected by cell searching, and the connection between the terminal device 200 and the base station device is established. Then, the connection switching of the base station device 100-1 to the second base station device is performed.

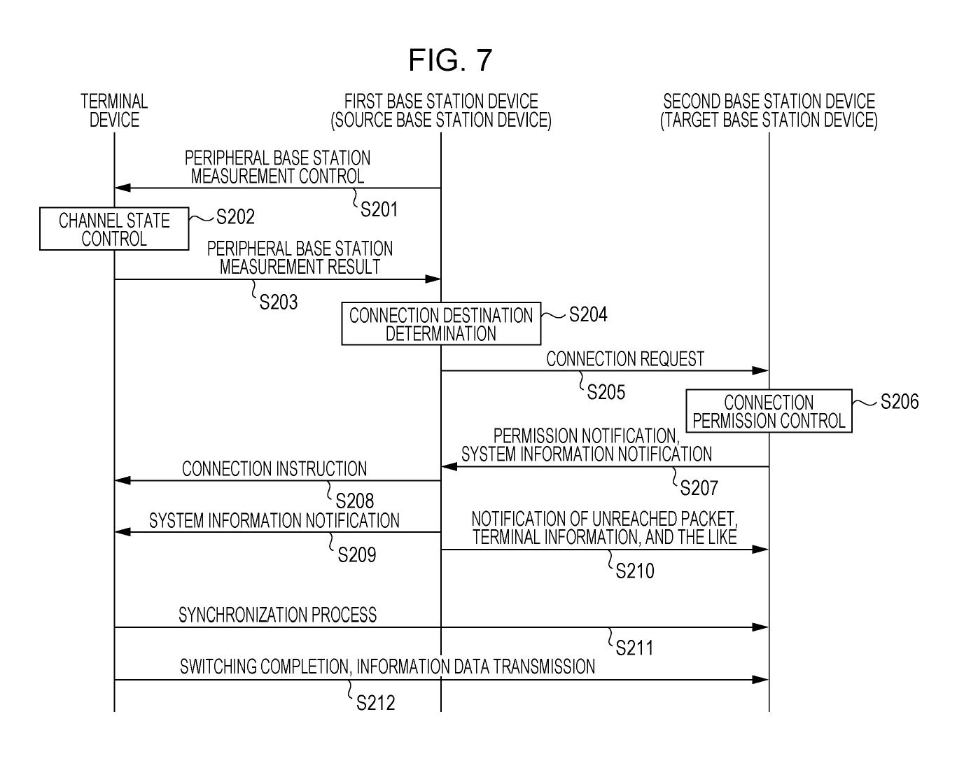

FIG. 7 is a sequence diagram showing the terminal device, in the communication system according to the first embodiment, being connected to the second base station device. FIG. 7 shows a case where the connection switching of a terminal device connected to the first base station device to the second base station device is performed. The source base station device is a base station device of a connection source, and a target base station device is a base station device of a connection destination.

When the terminal device 200 receives a notification of peripheral base station control from the base station device 100-1 which is a source base station device (S201), the terminal device measures a channel state between a base station device designated by the notification and its own base station (S202). In FIG. 1, the terminal device 200 measures a channel state between its own base station and the base station devices 100-2 to 100-5. A reference signal transmitted from each base station device can be used for the measurement of the channel state. For example, a CRS, an SRS, and a CSI-RS in LTE can be used.

The terminal device 200 notifies the base station device 100-1 of a measurement result (peripheral base station measurement result) of the channel state (S203).

The base station device 100-1 can determine a connection destination (target base station device) on the basis of the peripheral base station measurement result, a resource allocation condition of the terminal device, and the like (S204). It is preferable that the source base station device selects a base station device having high channel quality as a target base station device. The channel quality can be determined by a received power, an interference power, a reception SNR, a reception SINR, and the like. Here, it is assumed that the base station device 100-1 selects the base station device 100-3 as a target base station device.

The base station device 100-1 notifies the base station device 100-3 of a connection request (for example, a handover request) through the backhaul line 10 (S205). The base station device 100-3 determines whether connection can be performed (S206). When connection can be performed, connection preparation such as scheduling is performed (S206). The base station 100-3 notifies the base station device 100-1 of permission (handover request ACK/NACK) and system information (S207). The system information includes a system bandwidth, a system frame number, and the number of transmitting antennas of the base station device 100-3. As the system information, information notified by an MIB can be used.

When the base station device 100-1 receives a notification of permission, the base station device instructs the terminal device 200 to perform connection switching to the base station device 100-3 (S208). In addition, the base station device 100-1 notifies the terminal device 200 of the system information of the base station device 100-3 (S209). Here, when the first base station device already stores the system information, it is possible to omit the notification of the system information in S207. For example, when the target base station device for which the first base station device performs a connection request (S205) was selected as a target base station device in the past, the target base station device can be omitted.

When the terminal device 200 receives the connection instruction and the notification of the system information (S208 and S209), the terminal device performs the switching of a transmission destination and performs a synchronous process with the base station device 100-3 by using a random access channel (S211). Then, the terminal device 200 notifies the base station device 100-3 of the completion of the switching (notification to the effect that connection has been established) and transmits a data channel (information data) (S212).

According to the first embodiment, in a communication system in which a plurality of second base station devices are disposed so that the ranges thereof connectable to a first base station device entirely or partially overlap the first base station device, when the connection of a terminal device to the first base station device is changed to the connection to the second base station device, it is possible to reduce broadcast information. Thereby, it is possible to improve the efficiency of using a radio resource. In addition, the terminal device can be connected to the plurality of base station devices with a small delay.

### Second Embodiment

In a second embodiment, a description will be given of another aspect in which the connection of a terminal device to a second base station device is switched to the connection to a second base station device in a communication system in which the second base station device is disposed so as to overlap a cell of the first base station device.

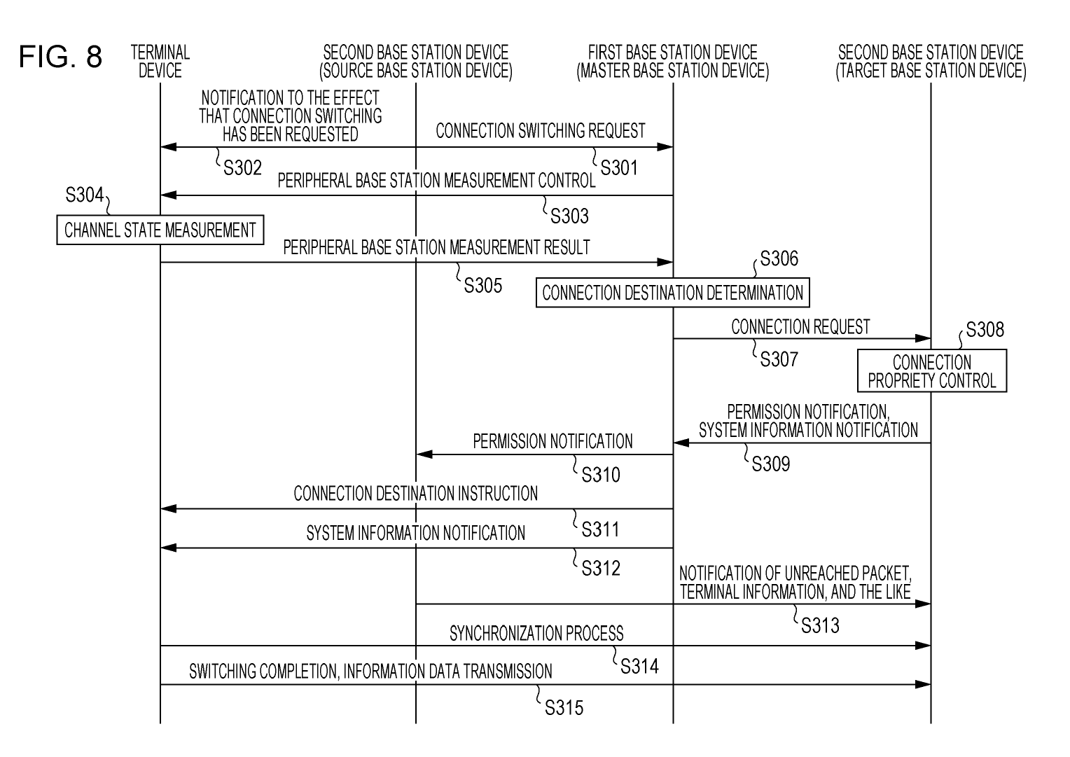

FIG. 8 is a sequence diagram showing the terminal device, in the communication system according to the second embodiment, being connected to the second base station device. In FIG. 1, it is assumed that the terminal device 200 is wirelessly connected to the base station device 100-3 belonging to the second base station device. In this case, the base station device 100-3 serves as a source base station device.

When a connection destination of the terminal device 200 is changed, the base station device 100-3 requests the base station device 100-1 (master base station device), which is the first base station device to perform connection switching (S301). For example, when a NACK signal for requiring retransmission in a downlink is continuously received from the terminal device 200 or errors of an uplink data channel from the terminal device 200 increase, the base station device 100-3 requests connection switching. In addition, the terminal device 200 can also make a request for connection with respect to a source base station device. In addition, the base station device 100-3 can notify the terminal device 200 of the connection switching request (S302).

When the terminal device 200 receives a peripheral base station measurement control notification from the base station device 100-1 having received the connection switching request in S301 (S303), a channel state between a base station device (target base station device candidate) designated by the notification and its own base station is measured (S304). In FIG. 1, the terminal device 200 measures channel states between its own base station and the base station device 100-2, between its own base station and the base station device 100-4, and between its own base station and the base station device 100-5. Meanwhile, the target base station device candidate may include the base station device 100-1. A reference signal transmitted from each base station device can be used for the measurement of the channel state. For example, a CRS, an SRS, and a CSI-RS in LTE can be used.

The terminal device 200 notifies the base station device 100-1 of a measurement result (peripheral base station measurement result) of the channel state (S305). The base station device 100-1 can determine a connection destination on the basis of the peripheral base station measurement result, a resource allocation condition of the terminal device, and the like (S306). It is preferable that the source base station device selects a base station device having high channel quality as a target base station device. Here, it is assumed that the base station device 100-1 selects the base station device 100-2 as a target base station device. That is, the second base station device (target base station device) of FIG. 8 serves as the base station device 100-2.

The base station device 100-1 notifies the base station device 100-2 of a connection request (for example, a handover request) through a backhaul line 10 (S307). The base station device 100-2 determines whether connection can be performed (S308). When connection can be performed, connection preparation such as scheduling is performed (S309). The base station 100-3 notifies the base station device 100-1 of permission (handover request ACK/NACK) and system information (S309). The system information includes a system bandwidth, a system frame number, and the number of transmitting antennas of the base station device 100-2. As the system information, information notified by an MIB can be used.

Here, when the first base station device already stores the system information, it is possible to omit the notification of the system information in S309. For example, the target base station device for which the first base station device performs a connection request (S307) was selected as a target base station device in the past, the target base station device can be omitted.

When the base station device 100-1 receives a notification of permission, the base station device notifies the base station device 100-3 of the permission (S310). In addition, the base station device 100-1 instructs the terminal device 200 to perform connection switching to the base station device 100-2 (S311). In addition, the base station device 100-1 notifies the terminal device 200 of the system information of the base station device 100-2 (S312).

The base station device 100-3 notifies the base station device 100-2 of terminal information of the terminal device 200, an unreached packet, and the like (S313). When the terminal device 200 receives the connection instruction and the notification of the system information (S311 and S312), the terminal device performs the switching of a transmission destination and performs a synchronous process with the base station device 100-3 by using a random access channel for the base station device 100-2 (S314). Then, the terminal device 200 notifies the base station device 100-3 of the completion of the switching (notification to the effect that connection has been established) and transmits a data channel (information data) (S315).

The first base station device according to the second embodiment may have the same configuration as in FIG. 2. A higher layer 101 of the first base station device according to the second embodiment may have a function of transmitting a permission notification (S310) to the second base station device through the backhaul line 10.

The second base station device according to the second embodiment may have the same configuration as in FIG. 3. A higher layer 151 of the second base station device according to the second embodiment can notify another second base station device of terminal information, unreached packet information, and the like through the backhaul line 10 (S313). The higher layer 151 of the second base station device according to the second embodiment may include information (S302) for notifying the connection switching to a downlink control channel. In addition, the higher layer 151 of the second base station device according to the second embodiment may include transmission timing information of frequency base station measurement control (S303) which is transmitted from the first base station device (master base station device) in the downlink control channel, in the notification (S302) to the effect that the connection switching has been performed.

The terminal device according to the second embodiment may have the same configuration as in FIG. 6. A control channel processing unit 205 of the terminal device according to the second embodiment can extract information for notifying the connection switching and transmission timing information of frequency base station measurement control and may notify a higher layer 210 of the extraction. The control channel processing unit 205 of the terminal device according to the second embodiment can extract frequency base station measurement control transmitted from the first base station device on the basis of the transmission timing information of the frequency base station measurement control.

The first base station device according to the second embodiment can perform the resource mapping of a downlink data channel, a downlink control channel, a broadcast channel, a downlink synchronization signal, and a downlink reference signal on the basis of transmission frame formats of the upper stage of FIG. 4 and the upper stage of FIG. 5. The second base station device according to the second embodiment can perform the resource mapping of a downlink data channel, a downlink control channel, a downlink synchronization signal, and a downlink reference signal on the basis of transmission frame formats of the lower stage of FIG. 4 and the lower stage of FIG. 5.

According to the second embodiment, in a communication system in which a plurality of second base station devices are disposed so that the ranges thereof connectable to a first base station device entirely or partially overlap the first base station device, when the connection of a terminal device to the second base station device is changed to the connection to another second base station device, it is possible to reduce broadcast information. Thereby, it is possible to improve the efficiency of using a radio resource. In addition, the terminal device can be connected between the plurality of second base station devices with a small delay.

In the second embodiment, the second base station device (target base station device) of FIG. 8 can directly transmit the permission notifications (S309 and S310) to the second base station device (source base station device) through the backhaul line 10.

Accordingly, the terminal device can perform connection switching between the second base station devices with a smaller delay.

In the embodiments of the present invention, it is possible to perform control so that the terminal device is connected to the second base station device only after being connected to the first base station device at an initial stage. In this case, it is possible to omit synchronization signals (a first synchronization signal and a second synchronization signal) in the transmission frame of the second base station device in the lower stage of FIG. 4 and the lower stage of FIG. 5. Thereby, it is possible to improve of the efficiency of using a radio resource. In S208 or S209 of FIG. 7, the first base station device can notify a synchronization timing between the second base station device and the terminal device. In S311 or S312 of FIG. 8, the first base station device can notify a synchronization timing between the second base station device and the terminal device. For example, the first base station device can notify a synchronization timing of the second base station device based on a synchronization timing of the first base station device. For example, the notification of the synchronization timing may be included in a control channel of a downlink. The terminal device can achieve the frame synchronization of a downlink, the acquisition of symbol synchronization, and fine adjustment on the basis of the notification of the synchronization timing. The synchronization unit 207 of the terminal device can perform a synchronous process on the basis of the notification of the synchronization timing.

Meanwhile, a program operating in the terminal device and the base station device according to the present invention is a program (program causing a computer to function) for controlling a CPU and the like so as to realize functions of the above-mentioned embodiments according to the present invention. Information handled in these devices is temporarily accumulated in a RAM at the time of its processing, is then stored in various types of ROMs or HDDs, and reading, correction and writing are, as necessary, performed thereon by a CPU. A recording medium having a program stored thereon may be any of semiconductor mediums (such as, for example, a ROM and a nonvolatile memory card), optical recording mediums (such as, for example, a DVD, a MO, a MD, a CD, and a BD), magnetic recording mediums (such as, for example, a magnetic tape and a flexible disk) and the like. In addition, not only the functions of the above-mentioned embodiments may be realized by executing a loaded program, but also the function of the present invention may be realized by performing processing in cooperation with an operating system, other application programs or the like, on the basis of the instruction of the program.

In addition, when distributed to the market, a program can be distributed in a state where the program is stored in a portable recording medium, or can be transmitted to a server computer connected through a network such as the Internet. In this case, a storage device of the server computer is also included in the present invention. In addition, all or part of the terminal device and the base station device in the above-mentioned embodiments may be typically realized as an LSI which is an integrated circuit. The respective functional blocks of the reception device may be individually formed into a chip, all or part thereof may be integrated and formed into a chip. When the respective functional blocks are formed as an integrated circuit, an integrated circuit control unit for controlling the functional blocks is added.

In addition, a method of forming an integrated circuit may be realized by a dedicated circuit or a general-purpose processor without being limited to an LSI. In addition, when technology for forming an integrated circuit replaced by an LSI appears with the development of semiconductor technology, it is also possible to use an integrated circuit to which the technology is applied.

In addition, the terminal device of the present invention is not limited to being applied to a mobile station device, and it is needless to say that the terminal device can be applied to stationary type or immovable type electronic devices installed indoors and outdoors, for example, AV equipment, kitchen equipment, cleaning and laundry equipment, air-conditioning equipment, office equipment, vending machines, and other equipment for living.

As sated above, although the embodiments of the present invention have been described in detail with reference to the accompanying drawings, the specific configurations are not limited to the embodiments, but designs and the like can be made without departing from the scope of the present invention.

### INDUSTRIAL APPLICABILITY

The present invention is suitable for using a communication system, a communication method, a base station device, and a mobile station device.

### REFERENCE SIGNS LIST

10 Backhaul line
100-1 First base station device
100-2, 100-3, 100-4, 100-5 Second base station device
101 Higher layer
102 Data channel generation unit
103 Control channel generation unit
104 Control signal generation unit
105 Reference signal generation unit
106 Resource mapping unit
107 Transmission signal generation unit
108 Transmission unit
109-NT Transmitting antenna unit
121-NR Reception antenna unit
122 Reception unit
123 Control signal detection unit
151 Higher layer
152 Data channel generation unit
153 Control channel generation unit
153 Control channel generation unit
154 Control signal generation unit
155 Reference signal generation unit
156 Resource mapping unit
157 Transmission signal generation unit
158 Transmission unit
159-NT Transmitting antenna unit
171-NR Reception antenna unit
172 Reception unit
173 Control signal detection unit
200 Terminal device
201-NR Reception antenna unit
202 Reception unit
203 Received signal processing unit
204 Channel estimation unit
205 Control channel processing unit
206 Data channel processing unit
210 Higher layer
221-NT Transmitting antenna unit
222 Transmission unit
223 Transmission signal generation unit
224 Data channel generation unit
225 Control channel generation unit
226 Reference signal generation unit

1-14. (canceled)

15. A base station device of a communication system that includes a terminal device able to be connected to a first base station device and one or more second base station devices, the base station device comprising:
a transmission unit which transmits a broadcast channel for notifying broadcast information of the first base station device and a downlink channel including a radio resource control signal for notifying system information of the second base station device,
wherein the system information of the second base station device includes information regarding a duplex frame format of the second base station device.

16. The base station device according to claim 15, wherein the system information of the second base station device includes broadcast information of the second base station device.

17. The base station device according to claim 15, wherein the system information of the second base station device includes the number of transmitting antennas of the second base station device.

18. The base station device according to claim 15, wherein the system information of the second base station device includes a system bandwidth of the second base station device.

19. The base station device according to claim 15, wherein the system information of the second base station device includes a system frame number of the second base station device.

20. The base station device according to claim 15,
wherein the first base station device includes a higher layer for determining a connection destination of the terminal device from at least a peripheral base station measurement result, and
wherein the higher layer acquires the system information of the second base station device determined to be a connection destination from the second base station device.

21. A transmission method of a first base station device of a communication system that includes a terminal device able to be connected to the first base station device and one or more second base station devices, the transmission method comprising:
a transmission process of transmitting a broadcast channel for notifying broadcast information of the first base station device and a downlink channel including a radio resource control signal for notifying system information of the second base station device,
wherein the system information of the second base station device includes information regarding a duplex frame format of the second base station device.

22. A terminal device which is able to be connected to a first base station device and one or more second base station devices, the terminal device comprising:
a reception unit which receives a broadcast channel for notifying broadcast information of the first base station device and a downlink channel including a radio resource control signal for notifying system information of the second base station device,
wherein the system information of the second base station device includes information regarding a duplex frame format of the second base station device.
